(19) United States
(12) Patent Application Publication
(10) Pub. No.: US 2012/0147623 A1
(43) Pub. Date: Jun. 14, 2012

(54) OPTICAL FILM ASSEMBLY, BACKLIGHT MODULE AND DISPLAY DEVICE

(76) Inventors: Chun-Yen Chang, Hsin-Chu (TW); Li-Wei Cheng, Hsin-Chu (TW)

(21) Appl. No.: 13/015,539

(22) Filed: Jan. 27, 2011

(30) Foreign Application Priority Data
Dec. 8, 2010 (TW) 099142799

(51) Int. Cl. F21V 8/00; G09F 13/04; G02B 5/02

(52) U.S. Cl. 362/609; 359/599; 362/97.1

(57) ABSTRACT

An optical film assembly includes a first prism film and a first diffusing film. The first diffusing film is disposed on the first prism film. The first prism film has a plurality of prism structures arranged in parallel with each other and arranged in an orientation direction. The first diffusing film has a tensile direction. An angle included between the tensile direction of the first diffusing film and the orientation direction of the prism structures of the first prism film is between 50 degrees and 130 degrees.

### BACKGROUND OF THE INVENTION

1. Field of the Invention

The invention relates to an optical film assembly and, more particularly, to an optical film assembly, which can be applied in a backlight module and a display device, capable of improving mura phenomenon effectively.

2. Description of the Prior Art

Since a liquid crystal display (LCD) has advantages of thin thickness, light weight, low power consumption, no radiation pollution, and being compatible with semiconductor process, it has been applied in various electronic devices including notebook, mobile phone, digital still camera, personal digital assistant, and so on. The LCD utilizes a backlight module to provide light for a display panel so as to display images. In general, the backlight module usually consists of a light source assembly and an optical film assembly. The light source assembly is used to provide light and the optical film assembly is used to improve optical characteristics of light. The optical film assembly may comprise lots of optical films including a prism film, a diffusing film, and so on.

At present the mura phenomenon may occur randomly in some LCDs with view angle between 20 degrees and 30 degrees. After researching the structure of those LCDs, it is found that the mura phenomenon may often occur randomly if the LCDs satisfy the following factors.

First factor: a top optical film of the backlight module is uneven.

Second factor: an angle included between a tensile direction of a top optical film (e.g. diffusing film) of the backlight module and an orientation direction of prism structures of a neighboring prism film is smaller than 50 degrees or larger than 130 degrees.

Third factor: the light source assembly of the backlight module may generate polarized light while a user watches LCD from side.

It is very difficult to overcome the aforesaid first and third factors in regard to current process of manufacturing LCD. Therefore, the aforesaid second factor may be undertaken to improve the mura phenomenon.

### SUMMARY OF THE INVENTION

An objective of the invention is to provide an optical film assembly, which can be applied in a backlight module and a display device, so as to solve the aforesaid problems.

According to one embodiment of the invention, an optical film assembly comprises a first prism film and a first diffusing film. The first diffusing film is disposed on the first prism film. The first prism film has a plurality of prism structures arranged in parallel with each other and arranged in an orientation direction. The first diffusing film has a tensile direction. An angle included between the tensile direction of the first diffusing film and the orientation direction of the prism structures of the first prism film is between 50 degrees and 130 degrees.

According to another embodiment of the invention, a backlight module comprises an optical film assembly and a light source assembly. The light source assembly is disposed under the optical film assembly. The structural design of the optical film assembly is mentioned in the above.

According to another embodiment of the invention, a display device comprises a backlight module and a display panel. The backlight module comprises an optical film assembly and a light source assembly. The light source assembly is disposed under the optical film assembly and the display panel is disposed on the optical film assembly. The structural design of the optical film assembly is mentioned in the above.

As mentioned in the above, the invention enables the angle included between the tensile direction of the diffusing film and the orientation direction of the prism structures of the prism film to be between 50 degrees and 130 degrees, so as to improve optical characteristics of light projected out of the optical film assembly. Therefore, the optical film assembly of the invention can improve the mura phenomenon effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a display device according to one embodiment of the invention.

FIG. 2 is a schematic diagram illustrating the first prism film and the first diffusing film shown in FIG. 1.

FIG. 3 is a schematic diagram illustrating a roll material for producing diffusing films.

FIG. 4 is a schematic diagram illustrating the angle included between the tensile direction of each traverse diffusing film and the orientation direction.

FIG. 5 is a schematic diagram illustrating the angle included between the tensile direction of each longitudinal diffusing film and the orientation direction.

FIG. 6 is a schematic diagram illustrating a display device according to another embodiment of the invention.

### DETAILED DESCRIPTION

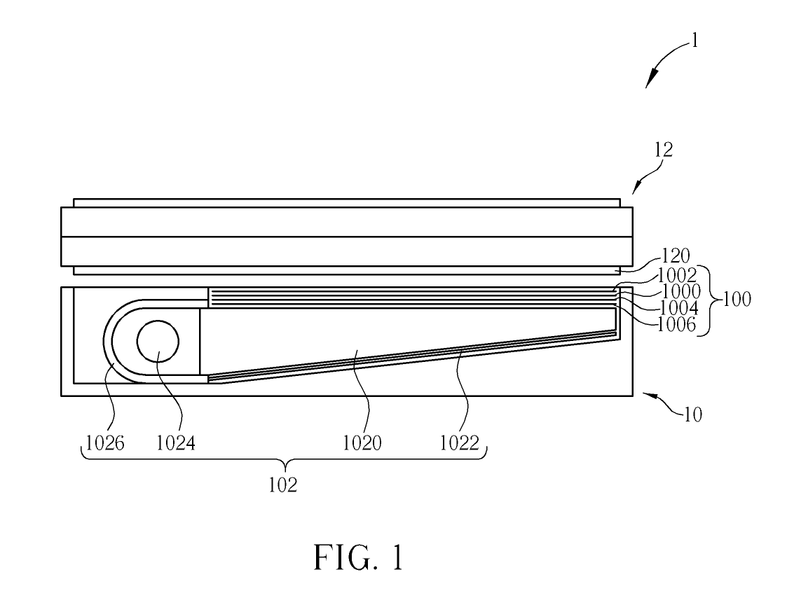

Referring to FIG. 1, FIG. 1 is a schematic diagram illustrating a display device 1 according to one embodiment of the invention. As shown in FIG. 1, the display device 1 comprises a backlight module 10 and a display panel 12. The backlight module 10 comprises an optical film assembly 100 and a light source assembly 102 disposed under the optical film assembly 100. In this embodiment, the display panel 12 may be a liquid crystal display (LCD) panel. The display panel 12 is disposed on the optical film assembly 100 of the backlight module 10. The optical film assembly comprises a first prism film 1000, a first diffusing film 1002, a second prism film 1004 and a second diffusing film 1006. The first diffusing film 1002 is disposed on the first prism film 1000, the second prism film 1004 is disposed under the first prism film 1000, and the second diffusing film 1006 is disposed under the second prism film 1004.

In this embodiment, the display panel 12 may comprise an advanced polarization conversion film (APCF) 120 disposed adjacent to the optical film assembly 100. In other words, after the display panel 12 is disposed on the backlight module 10, the APCF 120 is adjacent to the first diffusing film 1002 of the optical film assembly 100.

In this embodiment, the backlight module 10 is a side light type backlight module. Thus, the light source assembly 102 comprises a light guide plate 1020, a reflective sheet 1022, a light source 1024 and a reflective plate 1026. The light guide plate 1020 is disposed under the second diffusing film 1006 of the optical film assembly 100, the reflective sheet 1022 is disposed under the light guide plate 1020, the light source 1024 is disposed beside the light guide plate 1020, and the reflective plate 1026 is disposed around the light source 1024. In practical applications, the light source 1024 may be cold cathode fluorescent lamp (CCFL) or light emitting diode (LED) . It should be noted that the principle of the side light type backlight module is well known by those skilled in the art, so it will not be depicted herein.

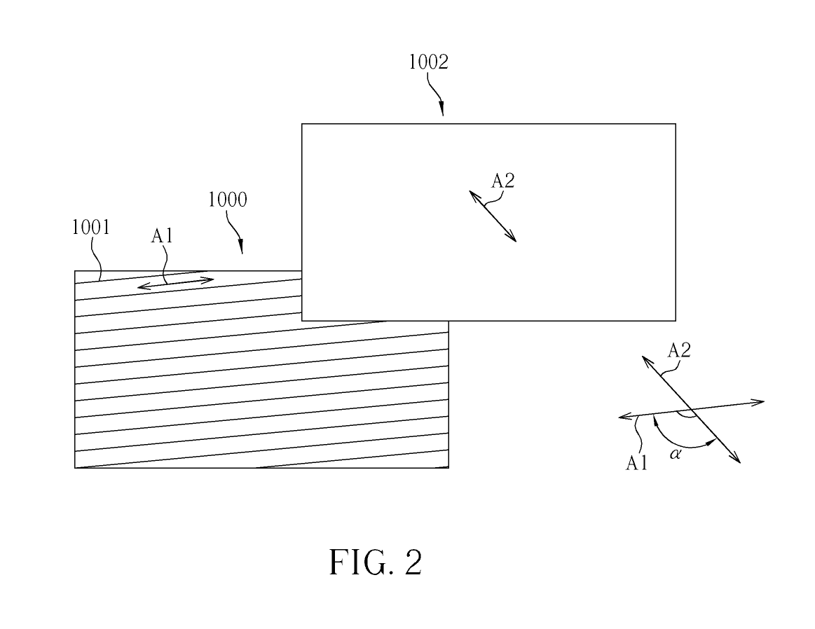

Referring to FIG. 2, FIG. 2 is a schematic diagram illustrating the first prism film 1000 and the first diffusing film 1002 shown in FIG. 1. As shown in FIG. 2, the first prism film 1000 has a plurality of prism structures 1001 arranged in parallel with each other and arranged in an orientation direction A1. Furthermore, the first diffusing film 1002 has a tensile direction A2. When the first diffusing film 1002 is disposed on the first prism film 1000, an angle α included between the tensile direction A2 and the orientation direction A1 is between 50 degrees and 130 degrees. In other words, the angle α, which is defined by a clockwise angle from the tensile direction A2 to the orientation direction A1, is between 50 degrees and 130 degrees, as shown in FIG. 2. Accordingly, the optical characteristics of light projected out of the optical film assembly 100 can be improved, so as to improve the mura phenomenon.

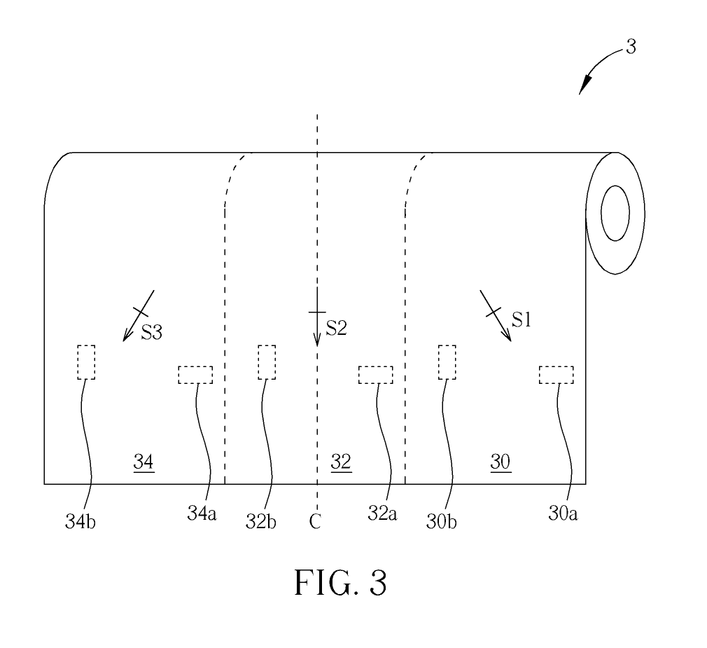

Referring to FIG. 3, FIG. 3 is a schematic diagram illustrating a roll material 3 for producing diffusing films. As shown in FIG. 3, the roll material 3 is divided into three sections 30, 32 and 34 with tensile directions S1, S2 and S3 respectively. It should be noted that there are only three arrows illustrated in FIG. 3 for indicating the tensile directions Sl, S2 and S3 respectively. In practical applications, the roll material 3 may be, but not limited to, PET film. For example, provided that a central axis C of the roll material 3 is defined as 0 degree, a counterclockwise angle from the central axis C is defined as positive angle, and a clockwise angle from the central axis C is defined as negative angle, the tensile direction S1 of the section 30 is substantially between 10 degrees and 35 degrees, the tensile direction S2 of the section 32 is substantially between 10 degrees and −10 degrees, and the tensile direction S3 of the section 34 is substantially between −10 degrees and −35 degrees. The invention may traverse cut the three sections 30, 32 and 34 of the roll material 3 or longitudinally so as to produce the first diffusing film 1002. As shown in FIG. 3, the sections marked by 30a, 32a and 34a are diffusing films traverse cut from the roll material 3, and the sections marked by 30b, 32b and 34b are diffusing films cut from the roll material 3 longitudinally.

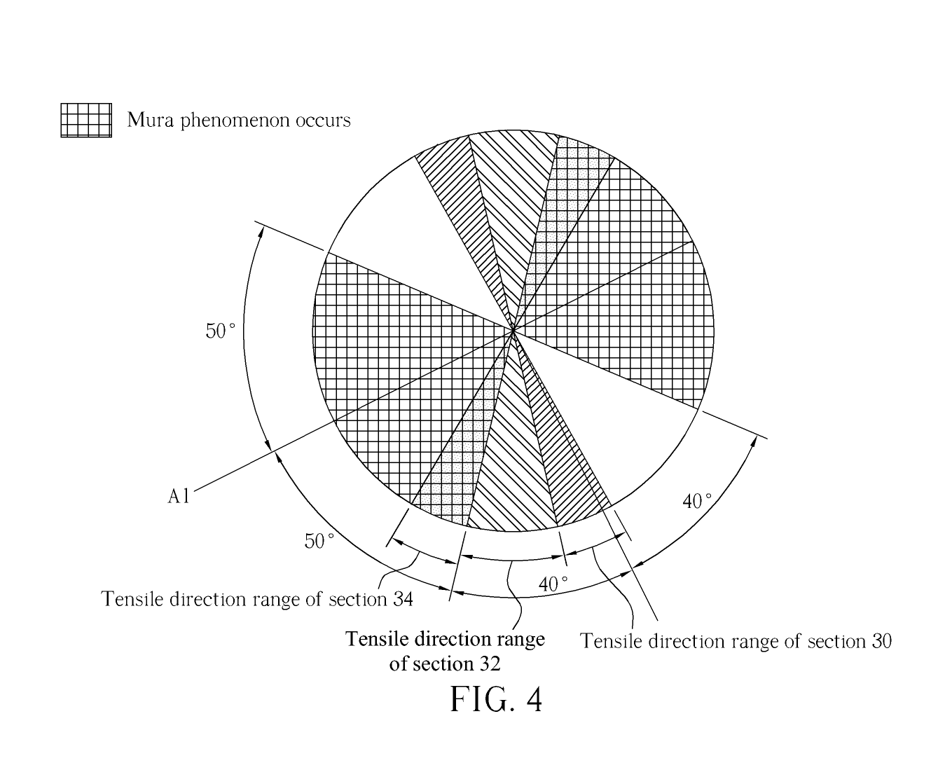

Referring to FIG. 4, FIG. 4 is a schematic diagram illustrating the angle included between the tensile direction of each traverse diffusing film and the orientation direction A1. If the roll material 3 is cut traverse to produce diffusing films, only the angle included between the tensile direction of the section 30 or 32 and the orientation direction A1 will be between 50 degrees and 130 degrees, as shown in FIG. 4. In other words, if the roll material 3 is cut traverse to produce diffusing films, the diffusing films cut from the sections 30 and 32 can cooperate with the aforesaid first prism film 1000 so as to improve the mura phenomenon.

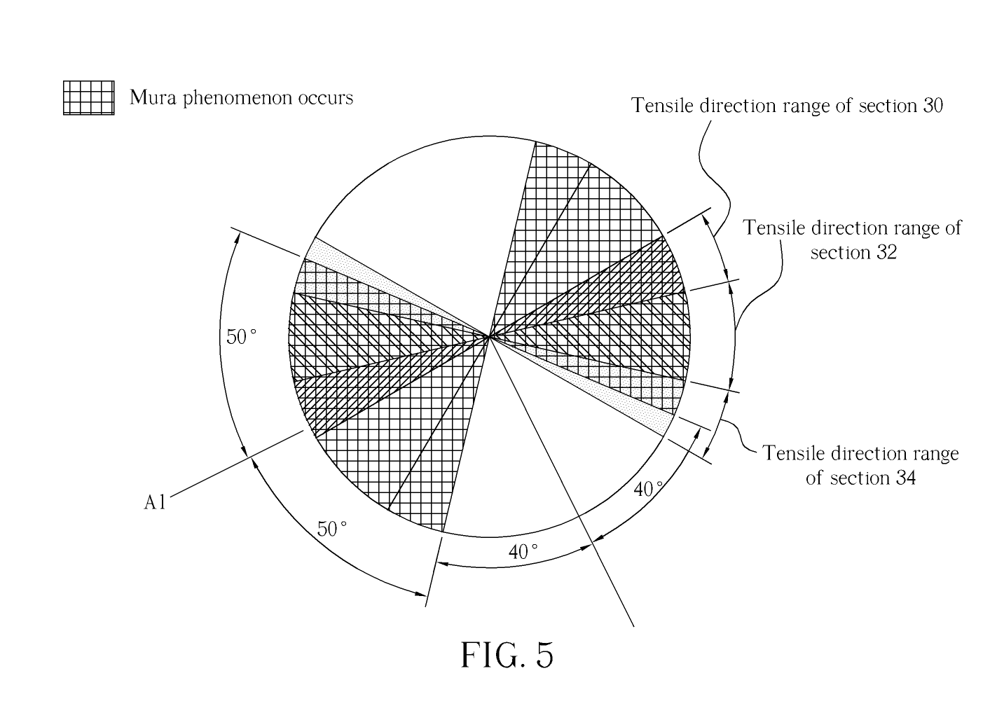

Referring to FIG. 5, FIG. 5 is a schematic diagram illustrating the angle included between the tensile direction of each longitudinal diffusing film and the orientation direction A1. If the roll material 3 is cut longitudinally to produce diffusing films, only the angle included between the tensile direction of partial section 34 and the orientation direction A1 will be between 50 degrees and 130 degrees, as shown in FIG. 5. In other words, if the roll material 3 is cut longitudinally to produce diffusing films, the diffusing films cut from the partial sections 34 can cooperate with the aforesaid first prism film 1000 so as to improve the mura phenomenon.

However, in regard to the embodiment shown in FIGs. 4 and 5, the specific orientation direction A1 of a prism film collocated with different tensile directions of different diffusing films is illustrated for description purpose only, and the invention shall not be limited to those tensile directions. That is to say, different orientation directions of different prism films can be collocated with different tensile directions of different diffusing films correspondingly, and the requirement for the invention is that the angle between the tensile direction and the orientation direction A1 must be between 50 degrees and 130 degrees.

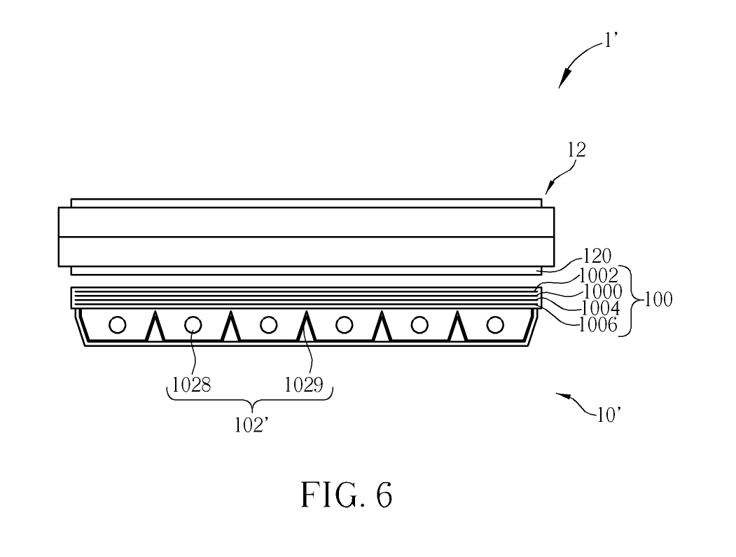

Referring to FIG. 6, FIG. 6 is a schematic diagram illustrating a display device 1′ according to another embodiment of the invention. The main difference between the display device 1′ and the aforesaid display device 1 is that the backlight module 10′ of the display device 1′ is a direct type backlight module. Thus, the light source assembly 102′ comprises a light source 1028 and a reflective plate 1029. The light source 1028 is disposed under the second diffusing film 1006 and the reflective plate 1029 is disposed under the light source 1028. In practical applications, the light source 1028 maybe cold cathode fluorescent lamp (CCFL) or light emitting diode (LED). It should be noted that the principle of the direct type backlight module is well known by those skilled in the art, so it will not be depicted herein. Furthermore, the same elements in FIG. 6 and FIG. 1 are represented by the same numerals, so the repeated explanation will not be depicted herein.

Compared to the prior art, the invention enables the angle included between the tensile direction of the diffusing film and the orientation direction of the prism structures of the prism film to be between 50 degrees and 130 degrees, so as to improve optical characteristics of light projected out of the optical film assembly. Therefore, the optical film assembly of the invention can improve the mura phenomenon effectively. In regard to a display device equipped with an APCF, the effect of the invention is more noticeable.

Those skilled in the art will readily observe that numerous modifications and alterations of the device and method may be made while retaining the teachings of the invention.

What is claimed is:

1. An optical film assembly comprising:
a first prism film having a plurality of prism structures arranged in parallel with each other and arranged in an orientation direction; and
a first diffusing film disposed on the first prism film, the first diffusing film having a tensile direction, an angle included between the tensile direction and the orientation direction being between 50 degrees and 130 degrees.

2. The optical film assembly of claim 1 further comprising:
a second prism film disposed under the first prism film; and
a second diffusing film disposed under the second prism film.

3. A backlight module comprising:
an optical film assembly comprising:
a first prism film having a plurality of prism structures arranged in parallel with each other and arranged in an orientation direction;
a second prism film disposed under the first prism film;
a second diffusing film disposed under the second prism film; and
a first diffusing film disposed on the first prism film, the first diffusing film having a tensile direction, an angle included between the tensile direction and the orientation direction being between 50 degrees and 130 degrees; and
a light source assembly disposed under the optical film assembly.

4. The backlight module of claim 3, wherein the light source assembly comprises:
a light guide plate disposed under the second diffusing film;
a reflective sheet disposed under the light guide plate;
a light source disposed beside the light guide plate; and
a reflective plate disposed around the light source.

5. The backlight module of claim 3, wherein the light source assembly comprises:
a light source disposed under the second diffusing film; and
a reflective plate disposed under the light source.

6. A display device comprising:
a backlight module comprising:
an optical film assembly comprising:
a first prism film having a plurality of prism structures arranged in parallel with each other and arranged in an orientation direction; and
a first diffusing film disposed on the first prism film, the first diffusing film having a tensile direction, an angle included between the tensile direction and the orientation direction being between 50 degrees and 130 degrees; and
a light source assembly disposed under the optical film assembly; and
a display panel disposed on the optical film assembly.

7. The display device of claim 6, wherein the optical film assembly further comprises:
a second prism film disposed under the first prism film; and
a second diffusing film disposed under the second prism film.

8. The display device of claim 7, wherein the light source assembly comprises:
a light guide plate disposed under the second diffusing film;
a reflective sheet disposed under the light guide plate;
a light source disposed beside the light guide plate; and
a reflective plate disposed around the light source.

9. The display device of claim 7, wherein the light source assembly comprises:
a light source disposed under the second diffusing film; and
a reflective plate disposed under the light source.

10. The display device of claim 6, wherein the display panel comprises an advanced polarization conversion film disposed adjacent to the optical film assembly.
